(19) United States
(12) Patent Application Publication
(10) Pub. No.: US 2006/0175110 A1
(43) Pub. Date: Aug. 10, 2006

(54) Mini two-wheel automobile

(76) Inventor: Min-Jan Lin, Pingtung City (TW)

Correspondence Address: TROXELL LAW OFFICE PLLC, SUITE 1404, 5205 LEESBURG PIKE, FALLS CHURCH, VA, 22041, US

(21) Appl. No.: 11/050,874

(22) Filed: Feb. 7, 2005

(51) Int. Cl. B62K 11/00

(52) U.S. Cl. 180/219

(57) ABSTRACT

A design and a manufacturing method for mini two-wheel automobiles include an automobile realm and a motorcycle realm for manufacturing a mini automobile running with two wheels and kept its balance during running by a principle of a gyroscope, as if it were a motorcycle. When it stops or runs very slowly, an intelligent fall-down frame provided in the mini two-wheel automobile automatically moves down to keep the automobile body balanced on the ground. The mini two-wheel automobile also has other safety designs and structures, with light, safe, gas-effective, convenient and comfortable property.

### BACKGROUND OF THE INVENTION

1. Field of the Invention

This invention relates to a a mini two-wheel automobile, particularly to one having mixed structures of an automobile and a motorcycle added with a safety design and structure.

2. Description of the Prior Art

As a new technological era has come, a wide variety of traffic tools have been created and developed. For example, automobiles are indispensable for every family in the developed countries, and its styles and types are countless for consumers to select. An automobile generally has many different functions and components, not only for driving or riding for daily work, deliver goods, and for many purposes, Especially in large cities, useable spaces are quite limited, and traffic infrastructure often cannot catch up with the speed of the growth of automobiles, causing traffic jams, gridlocks and extreme inconvenience for drivers, motorcyclists, cyclists and pedestrians in addition to serious deficit of parking lots. So many large cities around the world appeal and recommend their citizens to make use of public transporting tools such as buses, underground trains, etc. as much as possible to reduce traffic problems. Provided that most of workers drives a car available for five persons for going to work, returning hole from work, or going shopping, etc, the roads or streets in a large city can be overly crowded so as to cause slow traffic, jam or gridlock, if worse. If this situation is going on, there is no chance of improving the problem.

### SUMMARY OF THE INVENTION

A mini two-wheel automobile in the present invention includes a mixed structure of an automobile portion and a motorcycle portion, The automobile portion are a convention known art of the design and application of its body, an inner installation, and an engine, and the motorcycle portion is a body stabilizing device for slow speed, temporary stop, keeping stoppage, and parking. Once a driver enters the mini two-wheel automobile, the important part, the feet, is completely covered by the body, so when the mini automobile is in slow speed, temporary stop or parking, the driver does not need to extend out the feet for carrying out the movements above-mentioned, in other words, it is to design and make a mechanical feet of an intellectual landing frame having a similar function of human feet for the motorcycle portion. And the intellectual landing frame is composed of a speed sensor, a microcomputer controller and the landing frame.

### BRIEF DESCRIPTION OF DRAWINGS

This invention will be better understood by referring to the accompanying drawings, wherein:

FIG. 1 is a side view of a mini two-wheel automobile according to a design in the present invention, showing it under running condition;

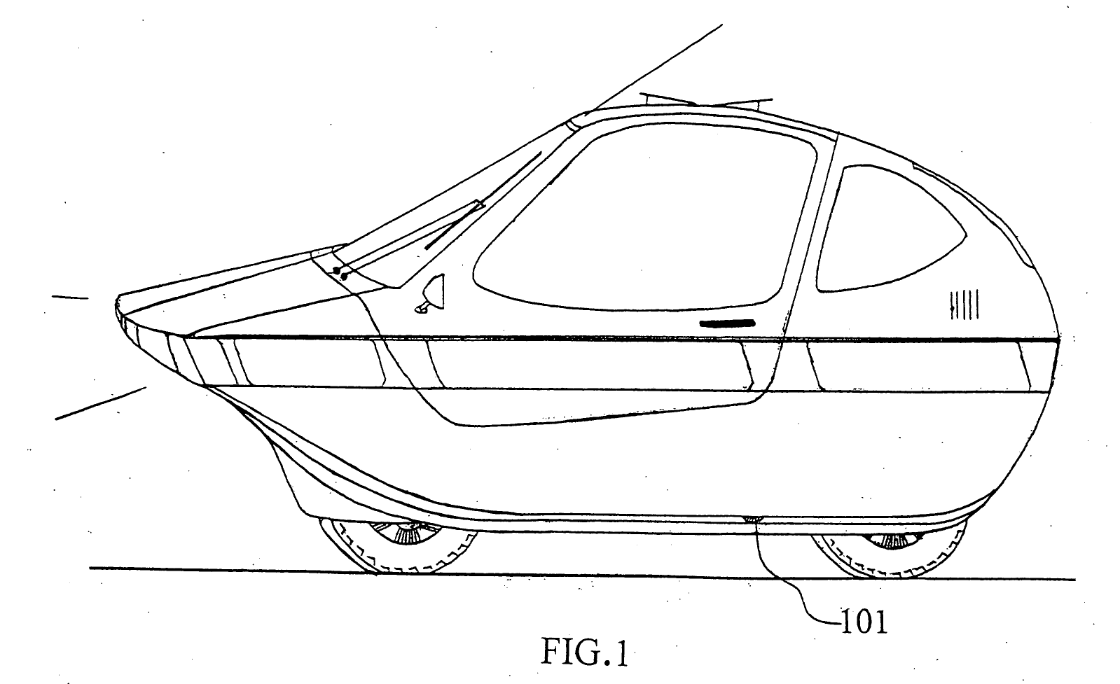

FIG. 2 is a perspective view of the body protecting steel frame in the present invention;

FIG. 3 is a side view of an intellectual landing frame in the present invention;

FIG. 4 is a perspective view of the inner sensor of the intellectual landing frame in the present invention;

FIG. 5 is a side view of the intellectual landing frame in the pulled-up condition in the present invention;

FIG. 6 is an upper view of the mini two-wheel automobile in the present invention;

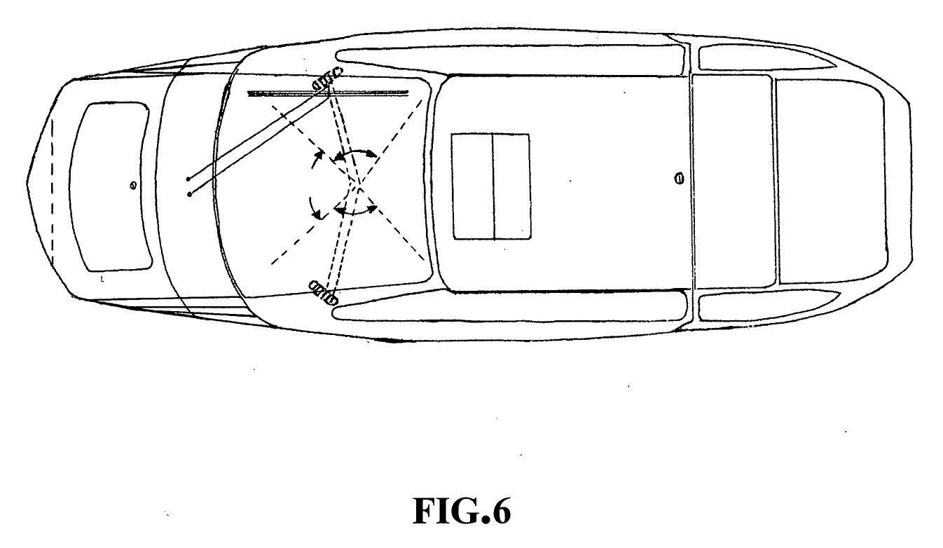

FIG. 7 is a bottom view of the mini two-wheel automobile in the present invention; and,

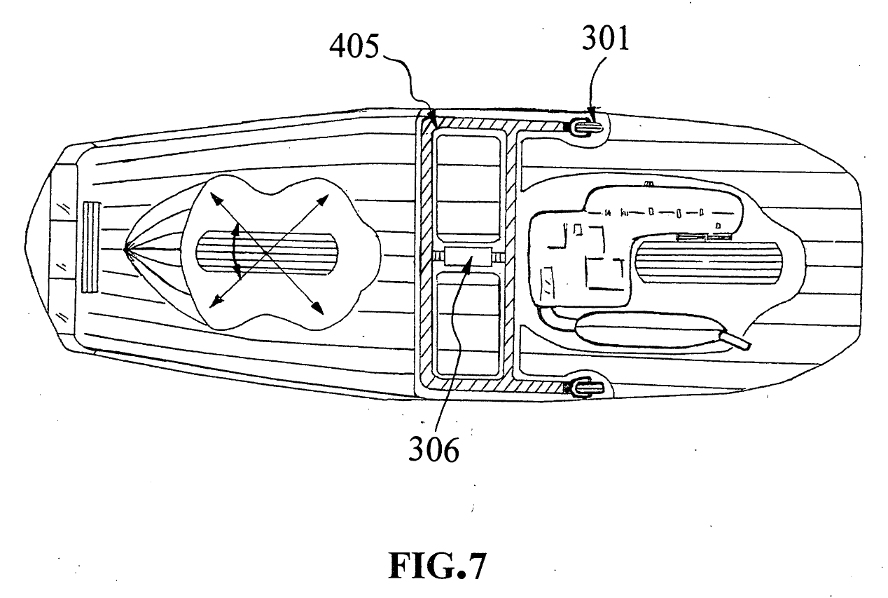

FIG. 8 is a side view of the first embodiment of the mini two-wheel automobile in the present invention.

### DETAILED DESCIPTION OF THE PREFERRED EMBODIMENT

A preferred embodiment of a mini two-wheel automobile in the present invention includes a structure of an automobile portion and that of a motorcycle portion. The automobile portion includes a body designed to have a single seat, streamline and low wind resistance, formed in a passenger type and a goods loading type. The inner installation includes a windshield wiper, rearview mirrors, a ceiling window, front and rear lights, an adjustable seat, a safety belt, an air conditioner, and audio devices. The motorcycle portion includes a 150 CC water-cooling or air-cooling automatic speed-changing engine as a motive power source, and a specially designed safety device. In order to prevent the mini automobile from falling down or sliding, a manual brake is provided in the inside, and a backing device is also provided in the inside, such as a backing device for a modified motorcycle for the crippled for changing a parking location. As for the door, it can be one easily taken off or like a cockpit cover liftable to the front or the rear for a fighter in case of flying in hot summer.

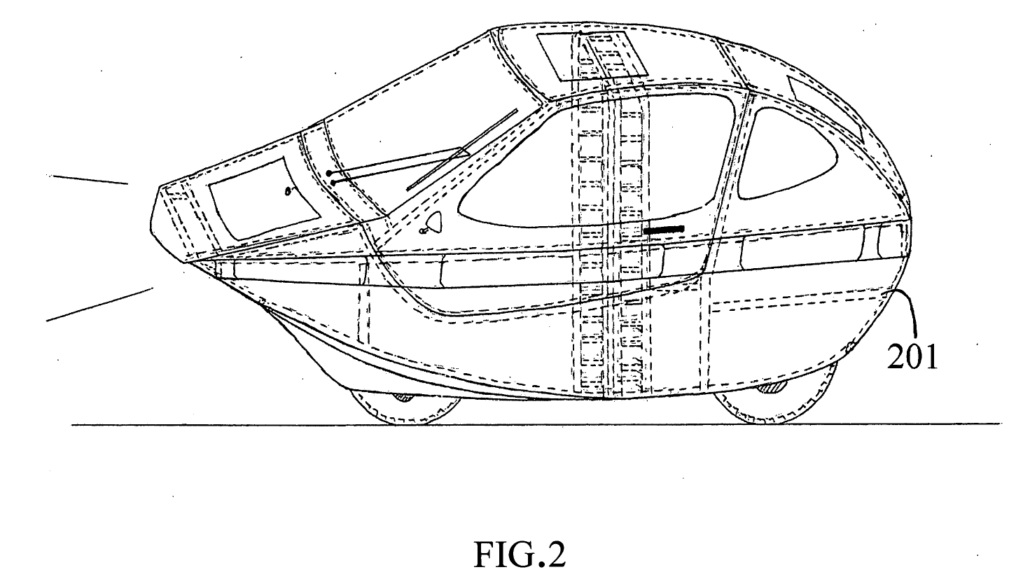

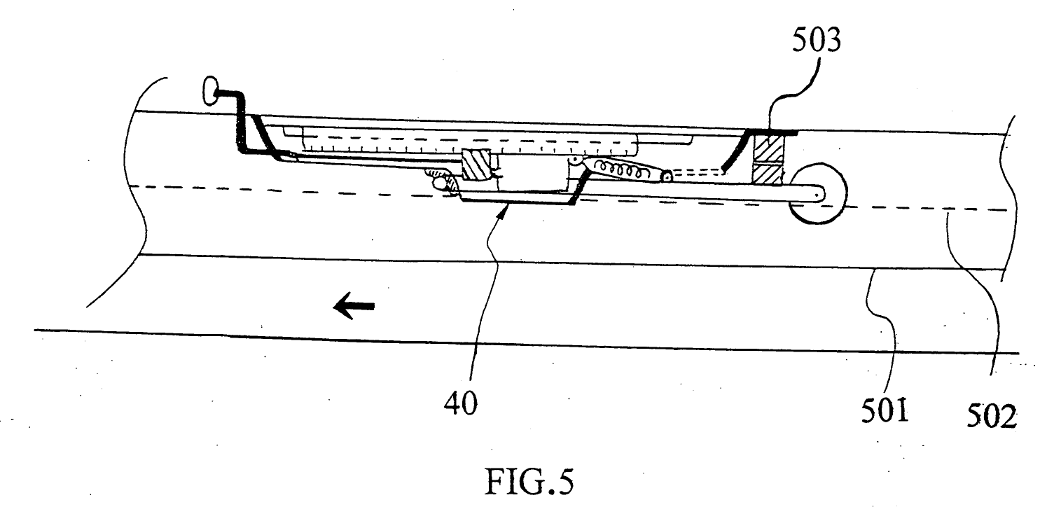

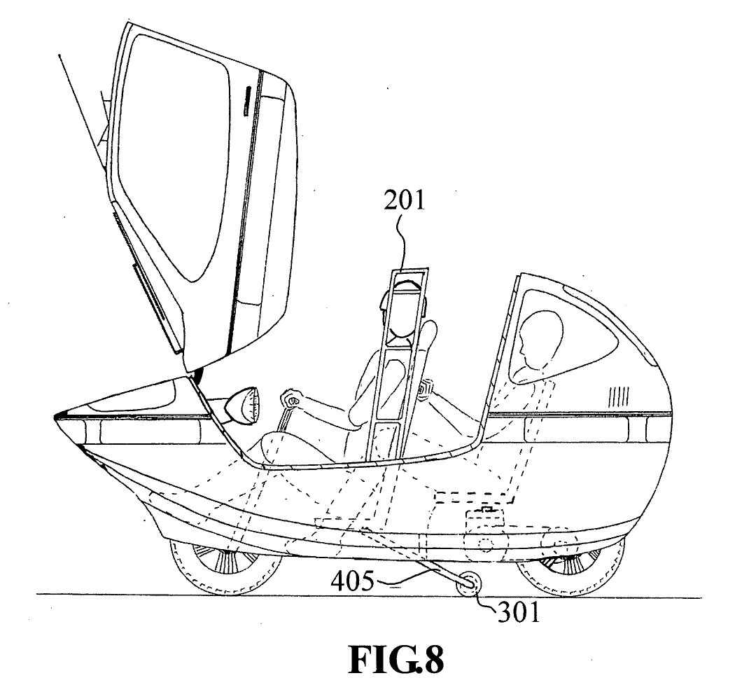

Next, FIGS. 2, 3, 4, 5 and 8 show respectively the body protecting steel frame, the intellectual landing frame in a landed condition, an inner sensor of the intellectual landing frame, the intellectual landing frame in the pulled-up condition, and the first embodiment of the invention. The body protective steel frame 201 shown by dotted lines in the figure is designed to protect a driver' body, and the body is made of glass fiber or steel, and formed in a stable balanced condition, not falling down but only possible to incline to the right or the left side, in case the intellectual landing frame 40 is in the pulled-up condition.

The design for the motorcycle portion includes a steering wheel 210, an intellectual landing frame 40, and a computer controller. The steering wheel is similar to the motorcycle handle, owing to the two-wheel type, or otherwise a driver may not be capable to keep the body stabled in driving. The intellectual landing frame 40 is composed of a speed sensor, a computer controller, and a landing frame 405.

The speed sensor can sense various speeds, produce signals of the car condition, and send signals to the computer controller. The speed sensor surely has to sense the wheel speed against the ground, by means of radar, sonar, electric wave or light sensing. Moreover, the speed sensor has capability of sensing the clockwise or the counterclockwise rotation of the wheels or stopping to cope with the forward and the backward movement and the stopping condition of the automobile.

The computer controller deals with the signals coming from the speed sensor, and sends output signals to control the operation of the landing frame 405, having a display for showing the movement and the position of the landing frame 405, and a manual switch for a driver to use. In case of backing or stopping, the landing frame 405 has to be in the landed condition, and the manual switch is in non-operation condition, for preventing the landing frame 405 from pulled up accidentally in case of backing. Further, a load sensor 404 is also provided for sensing the weight of the load of the car, enabling the driver to know the most suitable height for lowering down the landing frame 405 in order to cope with different loads or the weight of a driver. Further, a warning alarm is provided for giving out a verbal or sound warning for the driver to pay attention to the car body equilibrium in case of pulling up or lowering down the landing frame 405. In pulling up the landing frame 405, it has a preliminary movement for the driver to have enough time for adjusting the stability of his own body in case of accelerating or keeping on the same speed.

Next, A driving mode selecting switch is further provided in the mini automobile, for making changeover to an automobile module (four wheel running), a motorcycle mode (two wheel running). And a strong side wind mode (the landing frame lowered down half). When the speed reaches more than 35 miles per hour, it has to run in the motorcycle mode for achieving more stability, at the same time the warning system has to tell the driver in advance to be attentive to keeping the car body stably balanced. Further, an inertia sensor is provided for starting to lower the landing frame, without necessity of the speed sensor sensing the lower speed and then letting the landing frame lowered down. Thus, when a driver suddenly pushes the brake pedal during running with high speed, the landing frame 405 may be lowered down a little earlier for stably balancing the car body. The inertial sensor can be set to operate at 0.6 G or so, and in case the car slows down gradually and the landing frame 405 becomes out of order, it is necessary to let the warning system operate to give warning to the driver to use the manual handling for lowering down the landing frame 405.

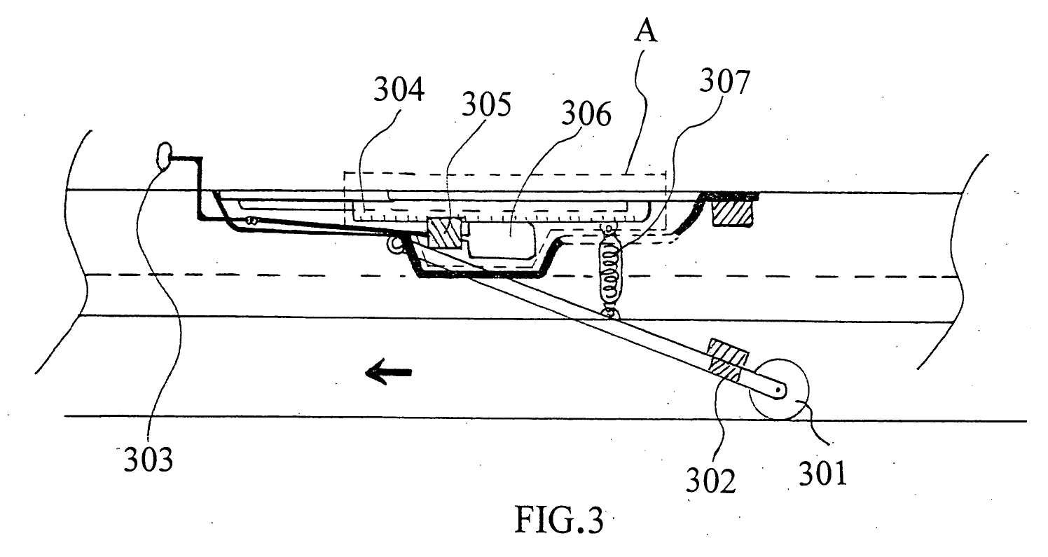

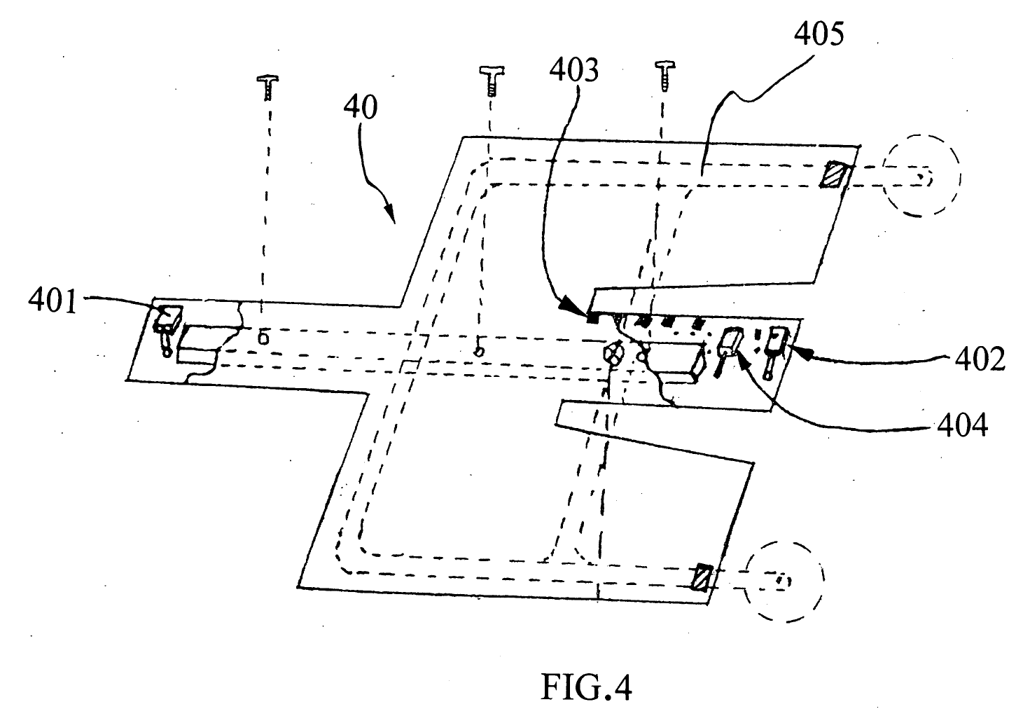

Next, FIGS. 3 and 4 show respectively the landing frame 405 lowered down and the inner sensor for the intellectual landing frame. The intellectual landing frame 40 is a kind of server, which receives directives from the microcomputer controller to operate the landing frame 405 to move up or lower down. And the intellectual landing frame 40 can be various kinds of servers including oil pressure types, air pressure types, mechanical types, electrical types, etc. Further, a reduced-speed transmitting device (A) is necessary for preventing the landing frame 405 from moving reversely during lowering down or lowered down, consisting of a movable rack 304, a speed-reducing gear 305, and a motor 306. The speed-reducing gear 305 can prevent reverse movement of the landing frame 405, and the landing frame 405 should have the most proper supporting means after lowered down, such as a small wheel 301 fixed respectively at two lower ends of the landing frame 405. Then the small wheel 301 can prevent the landing frame 405 from producing strong friction against the ground in case of lowering down or moving up with low speed. Further, The landing frame 405 has a connective rod 307 for connecting and shock absorbing, and the connective rod 307 has a proper shock absorbing distance (3 millimeters or so), with the function of absorbing almost all the vibrating width. Thus, the connective rod 307 and the small wheels 305 mutually cooperate to permit the landing frame 405 lowered down on the ground and keep it with the most proper supporting strength. In addition, a small shock absorbing device 302 is provided at the front of the wheel 305, having a shock absorbing distance 1 millimeter or so, functioning as a second shock absorber. Moreover, the small shock absorber 302 has a proper strength for preventing forward collision and side collision after lowered down, so the landing frame 405 may easily stand in 45 degrees on the ground for preventing forward collision.

Next, FIG. 4 shows the inner sensor of the intellectual landing frame 40. The landing frame 405 is shaped square and symmetrical at the right and the left side, indicated with dotted lines in the figures, capable to absorb completely shocks coming from any side. The inner sensor consists of a position sensor 403, an upper limit sensor 404 and a lower limit sensor 402 for sensing and sending signals to the micro computer controller for telling the moving distance, the location, and the weight of the landing frame 405. The manual auxiliary device for the landing frame 405 is normally located at the pulled-up position, and manually handled for lowering down only in case of the landing frame 405 being out of order, and it is a simple lever or a manual handle 303.

As described above, the automobile body, the inside installation, the engine, the speed sensor, the micro computer controller, and landing frame 405, etc are well known arts, and if they are assembled together according to the description foresaid, the mini two-wheel automobile can be manufactured

While the preferred embodiment of the invention has been described above, it will be recognized and understood that various modifications may be made therein and the appended claims are intended to cover all such modifications that may fall within the spirit and scope of the invention.

What is claimed is:

1. A mini two-wheel automobile, said mini two-wheel automobile comprising the structure of an automobile portion and a motorcycle portion, its characteristic being a kind of mini two-wheel automobile provided with an engine and an automobile body to completely cover a driver therein and capable to be kept in equilibrium by the theory of a gyroscope in case of slow speed running and stop without necessity of the driver extending the feet to the outside of the automobile, or any manual measures for keeping it in equilibrium, having a driving mode switch and an intellectual landing frame, said landing frame possible to be automatically pulled up from the landed condition during running of the automobile, said landing frame possible to be automatically lowered down on the ground during slow running or standing still of the automobile, thus said automobile body kept stable in equilibrium, not incline to the right or the left side.

2. The a mini two-wheel automobile as claimed in claim 1, wherein said engine is a 150 cc water cooling automatic speed-changing motorcycle engine.

3. The a mini two-wheel automobile as claimed in claim 1, wherein said engine is a 150 cc air cooling automatic speed-changing motorcycle engine.

4. The a mini two-wheel automobile as claimed in claim 1, wherein said driving mode switch has a mode of automobile driving mode (four wheel running).

5. The a mini two-wheel automobile as claimed in claim 1, wherein said driving mode switch ahs a mode of motorcycle driving mode (two wheel running).

6. The a mini two-wheel automobile as claimed in claim 1, wherein said driving mode switch has a strong side-wind mode (the landing frame being half lowered down).

7. The a mini two-wheel automobile as claimed in claim 1, wherein said intellectual landing frame is an oil pressure servo.

8. The a mini two-wheel automobile as claimed in claim 1, wherein said intellectual landing frame is an air pressure servo.

9. The a mini two-wheel automobile as claimed in claim 1, wherein said intellectual landing frame is a mechanical servo.

10. The a mini two-wheel automobile as claimed in claim 1, wherein said intellectual landing frame is an electrical servo.
